(19) United States
(12) Patent Application Publication
(10) Pub. No.: US 2021/0252683 A1
(43) Pub. Date: Aug. 19, 2021

(54) INSERT TOOL

(71) Applicant: Apache Industrial Services, Inc., Houston, TX (US)

(72) Inventor: KENNETH M. CHEVIS, Metarie, LA (US)

(21) Appl. No.: 16/792,214

(22) Filed: Feb. 15, 2020

(51) Int. Cl. B25B 27/14; F16B 37/12; E04G 17/065

(52) U.S. Cl. CPC B25B 27/143; E04G 17/0655; F16B 37/122

(57) ABSTRACT

A fastening system including a tool and at least one insert. The tool may include an input shaft having a hardness and an output shaft having the same hardness as the input shaft. The input shaft and the output shaft may be connected to each other and may define an internal tube along a longitudinal axis of the tool. A cylindrical insert may define a receiving tube that is configured to receive the output shaft.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

There are two types of concrete construction that require some form of formwork: vertical formwork and shoring. Vertical formwork provides the ability to form structures that hold vertical loads. Shoring provides the ability to form structures that hold horizontal loads. Vertical structures like walls, columns and foundations require formwork, and horizontal structures like slabs, beams and girders require shoring to cast them into place as an elevated structural component. Examples where shoring provides horizontal concrete members include: slabs, horizontal concrete girders, cross-t's under highways, etc.

In some older systems, it may be necessary to stabilize the formwork using a tie-rod within a PVC sleeve. After pouring concrete, the tie rod is removed and the PVC sleeve remains in the formwork. The tie-rod may be held in the formwork with a she-bolt and a stop washer. However, due to different formwork requirements, it is not always possible to use one type of tie-rod, she-bolt or stop washer.

### SUMMARY

An implementation of a tool may include an input shaft having a hardness and an output shaft having the hardness. The input shaft and the output shaft may be connected to each other and may define an internal tube along a longitudinal axis of the tool.

An implementation of a fastening system may include a tool and a cylindrical insert. The cylindrical insert may include an input shaft having a hardness and an output shaft having the hardness. The input shaft and the output shaft may be connected to each other and may define an internal tube along a longitudinal axis of the tool. The cylindrical insert may define a receiving tube, which may be configured to receive the output shaft.

A method of fastening formwork panels may include inserting an insert into a frame, inserting a rod into the insert, encircling a tool around the rod at a first end region of the insert, and rotating the tool and the insert together.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a formwork and a plurality of assemblies for shoring the formwork in accordance with implementations of various techniques described herein;

FIG. 2 illustrates a sleeve and a plurality of removable inserts in accordance with implementations of various techniques described herein;

FIG. 3 illustrates a cross-section of a sleeve;

FIG. 4 illustrates a first implementation of a removable insert;

FIG. 5 illustrates a second implementation of a removable insert;

FIG. 6 illustrates a third implementation of a removable insert;

FIG. 7 illustrates a formwork employing the third implementation illustrated in FIG. 6;

FIG. 8 illustrates a hand tool in accordance with implementations of various techniques described herein.

### DETAILED DESCRIPTION

In formwork systems, tie-rods and she-bolts are used to couple two panels of the formwork together. The tie-rod is inserted through a through-hole in a first panel and a coaxial through-hole in a second panel. She-bolts may be attached to the ends of the tie-rods. The she-bolts may help to set the proper depth of the tie-rod. The formwork is held in place by placing a washer and nut on opposing she-bolts.

A PVC sleeve may be placed in the formwork and the tie-rod may be inserted into the sleeve. The sleeve may be positioned in the formwork so that it extends from almost one panel of the formwork to almost an opposing panel. The sleeve would thus leave a gap between panels. Guide cones would connect the sleeve to the exterior of the formwork. The sleeve would prevent the tie-rod from getting irremovably embedded in concrete. The sleeve would remain in the concrete and the guide cones and the tie-rod would be removable. After removal of the tie-rod, a cap, plug or cement would be inserted into the recess left by the guide cones and smoothed over to form a surface that is flush with concrete previously poured into the formwork.

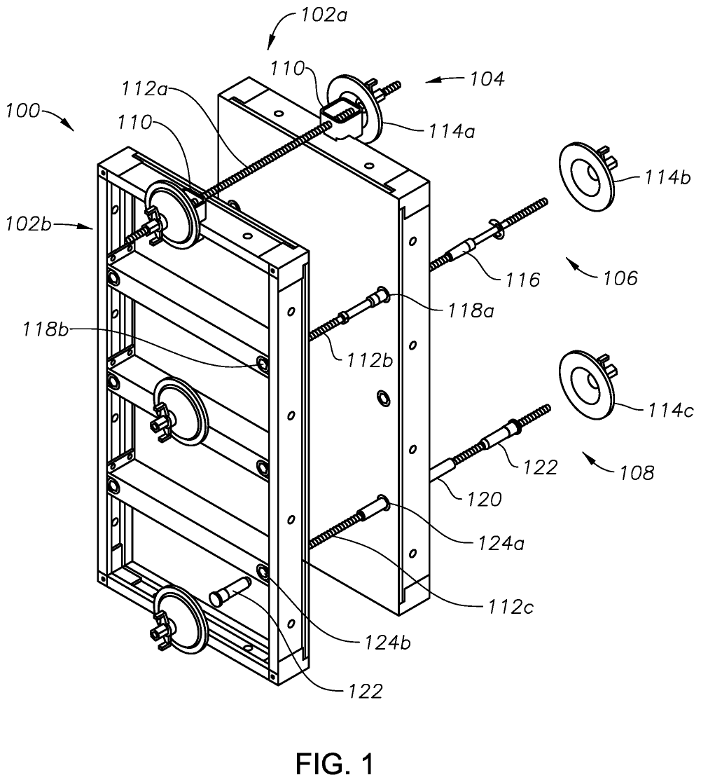

FIG. 1 illustrates a formwork assembly 100. A panel 102a may be coupled to panel 102b by assembly 104. Panels 102a and 102b may be coupled using different assemblies 104, 106 and/or 108. Assembly 104 may be a dry tie assembly, which may include dry tie brackets 110, a tie rod 112a and a tie-plate nut 114a. A person having ordinary skill in the art may have an understanding of assembly 104 and this assembly will not be discussed further.

An implementation is illustrated in FIG. 1 as assembly 106. Assembly 106 may be a she-bolt tie assembly, which may include a tie rod 112b, a she-bolt 116 and a tie-plate nut 114b. Tie rod 112b may be inserted into through-holes 118a and 118b of panels 102a and 102b, respectively. Each through-hole 118a and 118b may extend from a front surface of each panel to a rear surface of each panel. The tie rod 112b may be threaded and may engage the tie-plate nut 114b, which may also be threaded. This implementation will be discussed in more detail below.

A further implementation is illustrated as assembly 108. The assembly 108 may include a tie rod 112c, through-tie sleeve 120, tie-plate nut 114c and at least one insert 122. Tie rod 112c may be inserted into through-holes 124a and 124b of panels 102a and 102b, respectively. The tie rod 112c may be threaded and may engage the tie-plate nut 114c, which may also be threaded.

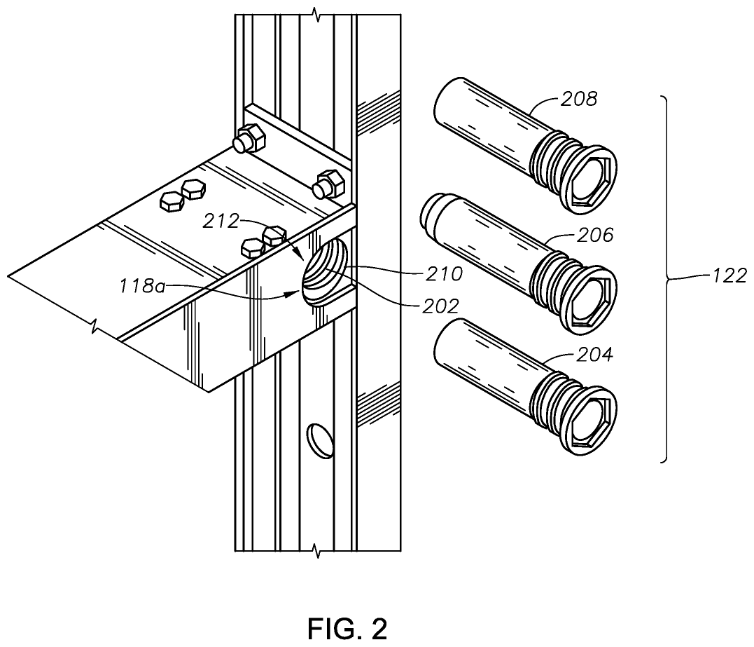

With reference to FIG. 2, a sleeve 202 may be inserted into any and all of the through-holes, for example, through-hole 118a. The sleeve 202 may irremovably engage the through-hole 118a and may be fully encompassed within through-hole 118a.

The insert 122 may be any one of a plug insert 204, a through-tie insert 206 or a multi-use insert 208. A distal end of the inserts 204, 206 and 208 may engage a recess 210 at a proximal end region 212 of the sleeve 202. Each of the sleeve 202, the plug insert 204, the through-tie insert 206 and the multi-use insert 208 may be cylindrical.

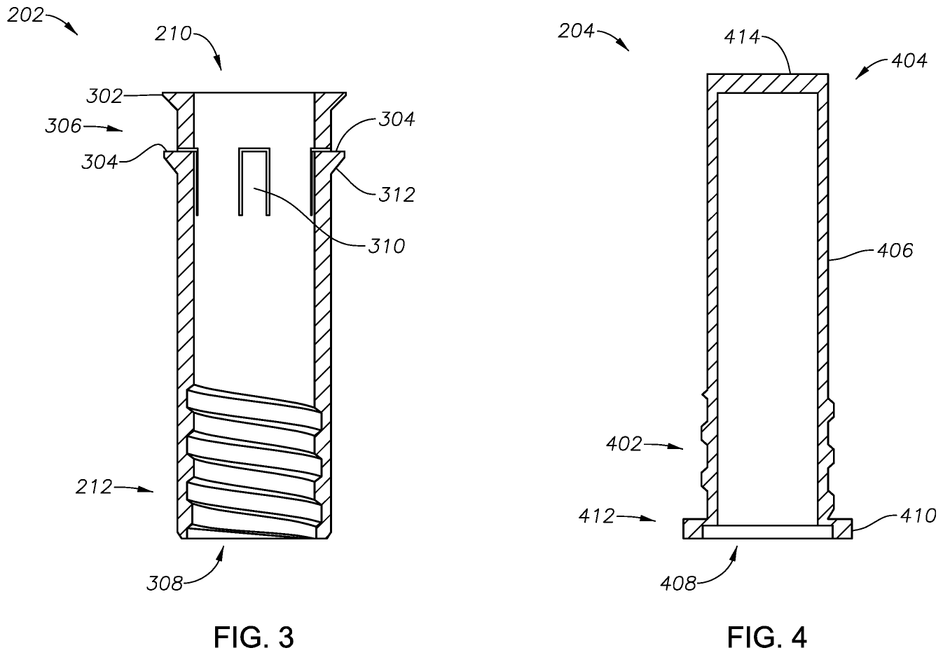

FIG. 3 illustrates a cross-section of the sleeve 202. The sleeve 202 may include the recess 210, a lip 302 and at least one detent 304 at a distal end region 306 and may include threads 308 at the proximal end region 212.

As disclosed above, the sleeve 202 engages a panel 102a or 102b by being inserted into the through-hole 118a. The sleeve 202 is inserted into the through-hole 118a via a rear side (not shown) of one of the panels, panel 102a, for example, and retained in the through-hole 118a by detent 304. The detent 304 is elongate and attached at one end 310 to the sleeve 202. The detent 304 has a sloped surface 312. The detent 304 is spring-like via its connection at the one end 310 to the sleeve 202.

Inserting the sleeve 202 into the through-hole 118a engages the sloped surface 312 with a surface of the panel defining the through-hole 118a. This engagement pushes the detent 304 into the sleeve recess 210 until the sleeve 202 is pushed far enough into the through-hole 118a so that the detent 304 passes the rear surface of the panel 102a and the proximal end region 212 of the sleeve 202 reaches the rear surface of the panel and the lip 302 engages the rear surface of the panel. Thus, the sleeve 202 is retained in the panel 102a by the detent 304.

An implementation of the plug insert 204 is illustrated in FIG. 4. The plug insert 204 may include threads 402, closed end 404, a cylindrical housing 406, a plug recess 408 defined by the cylindrical housing 406, and a rim 410 at proximal end region 412. The plug insert 204 may be substantially cylindrical.

The plug recess 408 may be multi-faceted. For example, a cross-section of the plug recess 408 may be hexagonal, rectangular, or triangular. The plug recess 408 may be configured to receive a tool for imparting torque on the plug insert 204. The tool for imparting torque will be discussed in detail below. The threads 402 of the plug insert 204 may engage threads 308 of the sleeve 202.

A flat surface 414 of the plug insert 202 helps to create a smooth surface for concrete poured into the formwork. For example, some formwork includes through-holes that are not occupied by an assembly 104, 106 or 108. The gap insert may be used to occupy the through-holes that are not occupied by an assembly. Upon inserting the plug insert 202 into a sleeve 202 within, for example, through-hole 118b, the flat surface 414 would be flush with an interior surface of the formwork, thereby leaving a substantially flat surface in the resulting concrete wall, panel, etc.

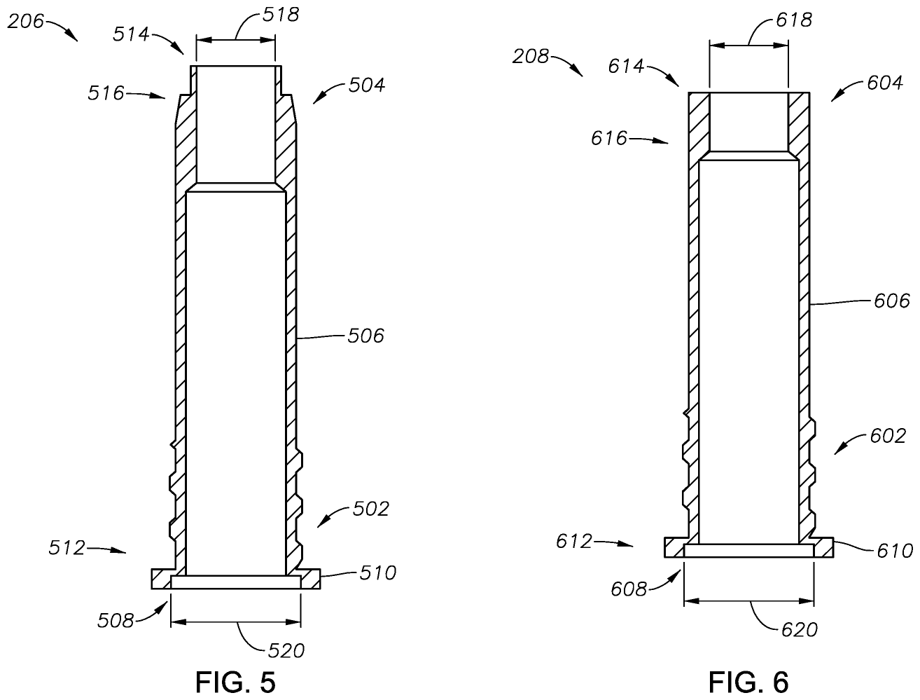

An implementation of the through-tie insert 206 is illustrated in FIG. 5. The through-tie insert 206 may include threads 502, open end 504, a cylindrical housing 506, a through-tie recess 508 defined by the cylindrical housing 506, and a rim 510 at proximal end region 512. The through-tie insert 206 may be substantially cylindrical.

The through-tie recess 508 may be multi-faceted. For example, a cross-section of the through-tie recess 508 may be hexagonal, rectangular, or triangular. The through-tie recess 508 may be configured to receive a tool for imparting torque on the through-tie insert 206. The tool for imparting torque will be discussed in detail below. The threads 502 of the through-tie insert 206 may engage threads 308 of the sleeve 202.

The through-tie insert 206 may engage the tie rod 112c (shown in FIG. 1). The tie rod 112c passes through a distal through-hole 514 at a distal end region 516 of the through-tie insert 206. The distal through-hole 514 is at an end of the through-tie insert 206 that is opposite the rim 510. The tie rod 112c may pass through the entire length of the through-tie insert 206 to and beyond the rim 510.

The through-tie recess 508 may have two widths. A first width 518 of the through-tie recess 508 at the distal end region 516 may be narrower than a second width 520 and may have a size substantially similar to a size of the tie rod 112c. Thus, the distal end region of the through-tie recess 508 may fit tightly with the tie rod 112c.

The tie rod 112c may have a width that is smaller than the second width 520 of the through-tie recess 508 such that a gap is between the tie rod 112c and the cylindrical housing 506.

The through-tie insert 206 may help to set a depth of the tie-rod 112c. For example, the rim 510 engages the distal end region 306 of the sleeve 202. Engagement of the rim 510 with the distal end region 306 may prevent the tie rod 112c from being too deep in the panel 102a.

The tie-plate nut 114c (shown in FIG. 1) may engage opposite ends of the tie rod 112c. Respective tie plate nuts 114c screw on the ends of the tie rod 112c as far down the tie rod 112c as possible until it meets a respective through-tie insert and/or a respective panel.

An implementation of the multi-use insert 208 is illustrated in FIG. 6. The multi-use insert 208 may include threads 602, open end 604, a cylindrical housing 606, a multi-use recess 608 defined by the cylindrical housing 606, and a rim 610 at proximal end region 612. The multi-use insert 208 may be substantially cylindrical.

The multi-use insert 208 may be multi-faceted. For example, a cross-section of the multi-use recess 608 may be hexagonal, rectangular, or triangular. The multi-use recess 608 may be configured to receive a tool for imparting torque on the multi-use insert 208. The tool for imparting torque will be discussed in detail below. The threads 602 of the multi-use insert 208 may engage threads 308 of the sleeve 202.

The multi-use recess 608 may include a distal through-hole 614 at an end of the multi-use insert 208 that is opposite the rim 610, a first width 618 at a distal end region 616 and a second width 620 at the proximal end region 612. The first width 618 may be smaller than the second width 620. The multi-use insert 208 may engage a plurality of ties, including a tie rod, a taper tie, a corner bracket tie rod, a she-bolt, etc. The multi-use recess 608 may engage any of the tie rod, taper tie, corner bracket tie rod, she-bolt, etc. at the distal end region 616 and fit tightly within the first width 618.

The tie rod, anchor, corner bracket tie rod, she-bolt, etc. may have a width that is smaller than the second width 620 of the multi-use recess 608 such that a gap is between the tie rod, taper tie, corner bracket tie rod, she-bolt, etc. and the cylindrical housing 606.

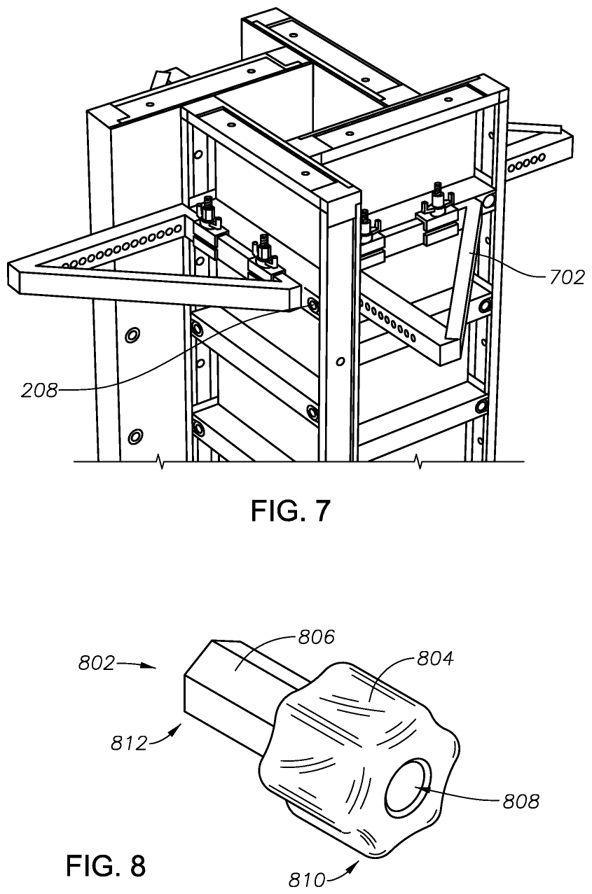

The multi-use insert 208 may be used with a tie rod, however, it is unnecessary. For example, as illustrated in FIG. 7, the multi-use insert 208 may be used with a corner bracket 702, which may be secured by a bolt, using the first width 618 of the multi-use recess 608 as a nut.

FIG. 8 illustrates an implementation of a tool 802 for imparting torque on the insert 122 (i.e., any of the inserts 204, 206 or 208). The tool 802 may include a columnar input shaft 804, a columnar output shaft 806 and an internal tube 808. The input shaft 804 and the output shaft 806 may be connected to each other in a coaxial manner and define the internal tube 808. The internal tube 808 may be coaxial with the input shaft 804 and the output shaft 806. The internal tube 808 may have a constant diameter and extend from a proximal end region 810 of the tool 802 to a distal end region 812 of the tool 802.

The tool 802 may be monolithic and may be made of the same material as the insert 122. An external surface of the output shaft 806 may be hexagonal, rectangular, or triangular to engage a recess of the insert 122 (i.e., a recess of any of the inserts 204, 206 or 208). A size of the output shaft 806 may be substantially consistent with a size of the gap between, for example, a tie-rod and the through-tie insert 206 so that the output shaft 806 fits in the gap. The tool 802 may engage the insert 122 with or without a tie-rod or other component present in the insert 122 and properly impart torque thereon.

With further reference to the implementation illustrated in FIG. 1, the assembly 106 may be a she-bolt tie assembly. The assembly 106 may be used without the insert 122. For example, the tie rod 112b may be inserted directly into the form work through sleeve 202. The tie-plate nut 114b may engage threads on opposite ends of the tie rod 112b and provide exterior limiters for the panels 102a and 102b. The thru-tie sleeve may be provided on an interior of the form work as an interior limiter of the panel, thereby working with the tie-plate nut 114b to maintain stability of the plates 102a and 102b.

A method of fastening a structure may include inserting the sleeve 202 into a frame, inserting the (secondary) insert 122 into the sleeve 202, and optionally inserting a rod into the insert 122. The tool 802 may encircle a first end of the rod, if present, and engage a recess of the insert 122 by which torque is imparted from the tool 802 to the insert 122. The insert 122 is thereby screwed into the sleeve 202. The tool 802 may be removed from the first end of the rod and used on a further (secondary) insert at a second end of the rod in the same fashion as the just installed insert 122.

In combination with the robust nature of the materials of the integrated construction system and the method of assembly, the cost to own the present integrated construction system is vastly reduced for both a dead asset basis, as well as the physical maintenance cost required to maintain a formwork and access inventory. In addition, the integrated construction system provides an increased flexibility to handle field applications, as well as increase the efficiency for the contractors that will use the integrated construction system to build concrete structures.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A tool comprising:
an input shaft, having a hardness; and
an output shaft having the hardness;
the input shaft and the output shaft connected to each other and defining an internal tube along a longitudinal axis of the tool.

2. The tool of claim 1, wherein the tool is monolithic.

3. The tool of claim 1, wherein the tool has radial symmetry.

4. The tool of claim 1, wherein the output shaft is a polygonal rod.

5. The tool of claim 4, wherein the polygonal rod includes at least six sides.

6. The tool of claim 1,
wherein:
the input shaft has a first outer diameter,
the output shaft has a second outer diameter, and
the first outer diameter is greater than the second outer diameter.

7. The tool of claim 6, wherein the defined internal tube extends from a distal end region of the tool to a proximal end region of the tool.

8. The tool of claim 7, wherein the defined internal tube has a substantially constant diameter along a length of the defined internal tube.

9. A fastening system comprising:
a tool including
an input shaft having a hardness; and
an output shaft having the hardness;
the input shaft and the output shaft connected to each other and defining an internal tube along a longitudinal axis of the tool; and
a cylindrical insert defining a receiving tube, the receiving tube configured to receive the output shaft.

10. The fastening system of claim 9, wherein the tool is monolithic.

11. The fastening system of claim 9, wherein the tool has radial symmetry.

12. The fastening system of claim 9, wherein the output shaft is a polygonal rod.

13. The fastening system of claim 12, wherein the polygonal rod includes at least six sides.

14. The fastening system of claim 9, wherein:
the input shaft has a first outer diameter,
the output shaft has a second outer diameter, and
the first outer diameter is greater than the second outer diameter.

15. The fastening system of claim 14, wherein the defined internal tube extends from a distal end region of the tool to a proximal end region of the tube.

16. The fastening system of claim 15, wherein the defined internal tube has a substantially constant diameter along the length of the defined internal tube.

17. A method of fastening formwork panels comprising:
inserting an insert into a frame;
inserting a rod into the insert;
encircling a tool around the rod at a first end region of the insert; and
rotating the tool and insert together.

18. The method of claim 17 further comprising:
removing the tool from the rod and encircling the rod at a second end region of the insert, wherein the second end region of the insert is disposed opposite of the first end region of the insert.

19. The method of claim 17, wherein the insert rotates in response to rotation of the tool.

20. The method of claim 19, wherein the tool is inserted into the insert.
